(19) United States
(12) Patent Application Publication
(10) Pub. No.: US 2014/0379148 A1
(43) Pub. Date: Dec. 25, 2014

(54) APPARATUS AND METHOD FOR OPERATION OF NETWORKED DRINKING FOUNTAINS

(71) Applicant: Wylie Sawyer, Norwalk, CT (US)

(72) Inventor: Wylie Sawyer, Norwalk, CT (US)

(73) Assignee: Wylie Sawyer

(21) Appl. No.: 14/311,231

(22) Filed: Jun. 20, 2014

Related U.S. Application Data
(60) Provisional application No. 61/837,251, filed on Jun. 20, 2013.

(51) Int. Cl. G05D 7/06; G06Q 30/02; G06Q 20/14; H04L 29/06; H04L 12/26

(52) U.S. Cl. CPC G05D 7/0629; H04L 67/42; H04L 43/08; G06Q 20/145; G06Q 30/0273
USPC 700/283; 705/14.69

(57) ABSTRACT

The present invention provides methods and an apparatus for at least one and including a network of enhanced drinking fountains that dispense water to the public while enabling a property owner or network operator to generate revenue from advertising, related promotional services and vending. The invention includes several embodiments of an apparatus that dispenses water, displays media content, facilitates user interactions and provides an efficient means for ensuring timely filter changes by transmitting water usage data to a server over a wide area network. By facilitating the generation of revenue, the present invention provides property owners and/or network operators with a way of offsetting the cost of purchasing, installing and maintaining enhanced drinking fountains. By improving upon the current state of the art, the present invention facilitates a faster and wider adoption of enhanced drinking fountains.

### CROSS-REFERENCE TO RELATED APPLICATIONS

The present application claims the benefit of priority to U.S. provisional patent application No. 61/837,251, filed on Jun. 20, 2013, titled: APPARATUS, SYSTEM AND METHOD FOR OPERATION OF A NETWORK OF DRINKING FOUNTAINS, and all the benefits accruing therefrom under 35 U.S.C. §119(e), the entire disclosure of which is hereby incorporated by reference in its entirety.

### FIELD OF THE INVENTION

The disclosure relates to drinking fountains. In particular, the disclosure relates to an apparatus, system and methods for operation of a network of drinking fountains.

### BACKGROUND OF THE INVENTION

Various means for providing drinking water to people in public locations, such as schools, colleges, fitness centers, shopping malls, airports, sports arenas, parks and entertainment venues are commonly used. In many jurisdictions building codes require owners of such locations to provide access to drinking water. Such requirements are usually satisfied by the installation of drinking fountains, which in the United States must comply with regulations promulgated under the Americans with Disabilities Act of 1990. Drinking fountains that meet the minimum requirements of the ADA are often under-utilized by the public. People in public locations will often choose to purchase bottled water or some other packaged beverage rather than satisfy their thirst from a public drinking fountain.

In recent years several companies have begun to supply the market with ADA compliant drinking fountains that include additional features such as filtration and bottle filling components that make them more attractive to the public. In addition to the cost of purchasing and installing an enhanced drinking fountain, there is also an additional cost associated with the filters or other water treatment systems that make the enhanced drinking fountains more popular with the public. Because filters generally have a limited lifespan based on the amount of water that has passed through them, most enhanced drinking fountains have a mechanism for estimating the amount of water that has passed through the system. In the present state of the art, this water usage data is stored locally and requires a person to visit the enhanced drinking fountain in order to determine when a filter change is required. While enhanced drinking fountains have proven successful in the marketplace, their rate of adoption is stunted because many property owners prefer to avoid the additional cost and time associated with the task of purchasing, installing and maintaining enhanced drinking fountains.

In recent years there has been a proliferation of digital place-based media networks in public locations such as shopping malls, fitness centers and airports. These networks are deployed by network operators who contract with property owners to obtain rights to operate digital signage in busy locations at a given property. Because the digital place based signage industry is supported by advertising revenues, it is imperative that the industry is able to attract the attention of people who come into proximity with the digital signage. By placing signage into a context where there is a captive audience, the industry is in a better position to sell space to advertisers. Thus for example, successful place-based networks have been installed inside of elevators and above gas pumps, where the signage is attractive to people who tend to be relatively less distracted while riding the elevator or pumping gasoline. However, while such networks have been successful, the number of public places where there is a relatively undistracted and thus captive audience is limited, thus the opportunities for these networks to grow will become diminished over time. While advertisers generally covet the opportunity to reach younger audiences (below the age of 25), the digital place based advertising industry has had only very limited success in establishing networks in high schools and colleges where the younger audience can be reached. For various reasons, administrators of colleges and high schools generally do not allow the placement of digital signage for the display of advertorial content on their respective campuses. These reasons generally relate to a belief that students should not be exposed to an undue amount of commercial messages while they are on campus.

The vending machine and beverage vending industries have thrived in part because people often prefer to purchase a beverage from a vending machine rather than obtain water from a drinking fountain. In most cases, beverages that are vended list water as their primary ingredient. In some cases plain water is packaged in a bottle and dispensed by the vending apparatus to the user as a finished product. The economic costs associated with the transport of packaged beverages from distribution centers to vending machines is borne in part by the vending industry while the environmental costs, in the form of pollution from the transport, production and disposal of disposable bottles, is externalized onto society at large. In other cases, the vending apparatus dispenses the water into a container provided by the user. In this latter case, sometimes the water is delivered via truck to the apparatus, however there are a very limited number of examples in prior art where the vending apparatus dispenses mains water into a bottle supplied by the user. By charging a fee to users for the dispensing of mains water, these examples of prior art do not satisfy building codes that require certain property owners to provide access to drinking water. There are a limited number of examples of prior art where the vending apparatus is able to mix additives such as flavors to mains water before it is dispensed. In this latter case, there are additional costs associated with the manufacture and maintenance of technology necessary to reliably mix additives with mains water. While there may be examples where separately packaged water additives are available in vending machines, there are no examples where such vending machines are incorporated into or designed to be placed within immediate proximity to a drinking fountain.

A need therefore exists for an improved apparatus, system and method for operation of drinking fountains.

### SUMMARY OF THE INVENTION

The present invention provides methods and an apparatus for at least one and including a network of enhanced drinking fountains that dispense water to the public while enabling a property owner or network operator to generate revenue from advertising, related promotional services and vending. The invention includes several embodiments of an apparatus that dispenses water, displays media content, facilitates user interactions and provides an efficient means for ensuring timely filter changes by transmitting water usage data to a server over a wide area network. By facilitating the generation of revenue, the present invention provides property owners with a way of offsetting the cost of purchasing, installing and maintaining enhanced drinking fountains. By providing a network operator with the means for generating revenue from the deployment of enhanced drinking fountains, the present invention enables a network operator to provide enhanced drinking fountains to property owners at no cost. In a scenario where a network of enhanced drinking fountains is dispersed over a wide area it becomes especially challenging to ensure that filters are changed in a timely manner. The mechanism for sending water usage data to a remote server over a wide area network as described in the present disclosure provides for a more efficient system of timely filter changes for a property owner or network operator who is operating a network of enhanced drinking fountains that are dispersed over a wide area. By improving upon the current state of the art, the present invention facilitates a faster and wider adoption of enhanced drinking fountains.

The combination of features embodied in the present invention, including a media display device that receives media content from a remote server, an interface for user interactions and the features of an enhanced drinking fountain, provide operators of digital place based media networks with a powerful new way to attract a captive audience for advertisers. The apparatus described in the present disclosure provides a means for a person to fill a bottle with water. During the time it takes for the bottle to be filled, the person is relatively less distracted and thus more likely to pay attention to and interact with media content. By including a mechanism for dispensing water, a media display device and an interface for user interactions with media content, the apparatus of the present invention facilitates a greater level of engagement and additional revenue opportunities as compared with prior art. Because the apparatus of the present invention may satisfy the requirements of building codes for the provision of water in public buildings, the apparatus described in the present disclosure can conveniently be installed in locations currently occupied by existing drinking fountains. The aspect of the present invention whereby a previously installed enhanced drinking fountain may be modified to accommodate a media display device and a wide area network connection to a remote server opens the door to a plethora of locations where operators of place based digital signage networks can operate that were otherwise not available under the state of prior art. By combining the advantages of an enhanced drinking fountain with a media display device, the present invention provides operators of digital place based networks with an added inducement that they can use to convince administrators of colleges and high schools to accept the intrusion of advertorial content in exchange for the benefit of an enhanced drinking fountain. Thus the present invention delivers improved functionality and opens the door to new opportunities for the digital place based advertising industry.

Certain embodiments of the present disclosure describe a water dispensing apparatus combined with a vending apparatus that is specifically configured to sell products related to drinking water. These products include for example, empty water bottles, and packets or bottles of powder or liquid that a user can add to water in order to enhance the flavor or efficacy of the water. By combining a water dispensing apparatus that dispenses mains water at no cost to users with such a vending apparatus the present invention represents an improvement over the current state of the art of the vending industry. By enabling a property owner to satisfy building codes that require provision of drinking water with an opportunity for generating revenues from vending, the present invention may offset the costs of an enhanced drinking fountain and thereby provide property owners with an incentive to upgrade their drinking fountains.

### BRIEF DESCRIPTION OF THE SEVERAL VIEWS OF THE DRAWING

The disclosure is illustrated by way of example, and not by way of limitation, in the figures of the accompanying drawing and in which like reference numerals refer to similar elements and in which:

FIG. 1 illustrates a conventional drinking fountain;

FIG. 2 illustrates an enhanced drinking fountain that includes a bottle filling component;

FIG. 3 illustrates an enhanced drinking fountain with an enclosure for a media display device;

FIG. 4 illustrates a media display kit that can be retrofitted onto an enhanced drinking fountain;

FIG. 5 illustrates a manner of modifying an enhanced drinking fountain so as to facilitate an electrical connection between a media display device and an electrical receptacle;

FIG. 6 illustrates an enhanced drinking fountain with a vending apparatus;

FIG. 7 illustrates a diagram of various connections that may exist between components of an example of the invention; and,

FIG. 8 illustrates a diagram of various interactions between a user and a water dispensing apparatus.

### DETAILED DESCRIPTION OF THE INVENTION

One aspect of the present invention provides a water dispensing apparatus that includes components that are generally present in the enhanced drinking fountains available in the present state of prior art, along with components that are not available in prior examples of enhanced drinking fountains. It is the unique combination of certain components with those typical of enhanced drinking fountains that make the present invention novel and superior to existing art.

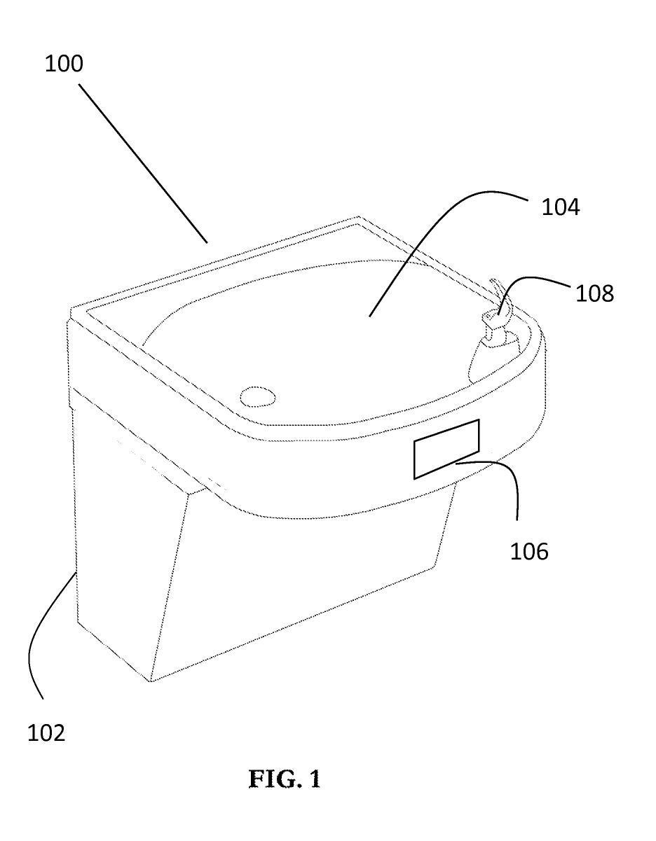

FIG. 1 illustrates a conventional drinking fountain 100. Conventional drinking fountains are generally comprised of one or more housings 102, one or more basins 104, a connection to mains water, a mounting bracket for the housing(s), a connection to a drain line, an interface for controlling the flow of water (which may include one or more buttons that are connected to a solenoid valve 106, one or more bubbler nozzles that provide a stream of water for immediate drinking 108, a water chilling device (such as a condenser or other type of water cooling device), connections between mains water, the water chilling device and the bubbler nozzle(s), connections between the basin(s) and the drain line and an electrical power line that connects the water cooling device to a source of electrical power. Water connections, the drain connection, electrical connections and the water chilling device are typically situated within the housing(s).

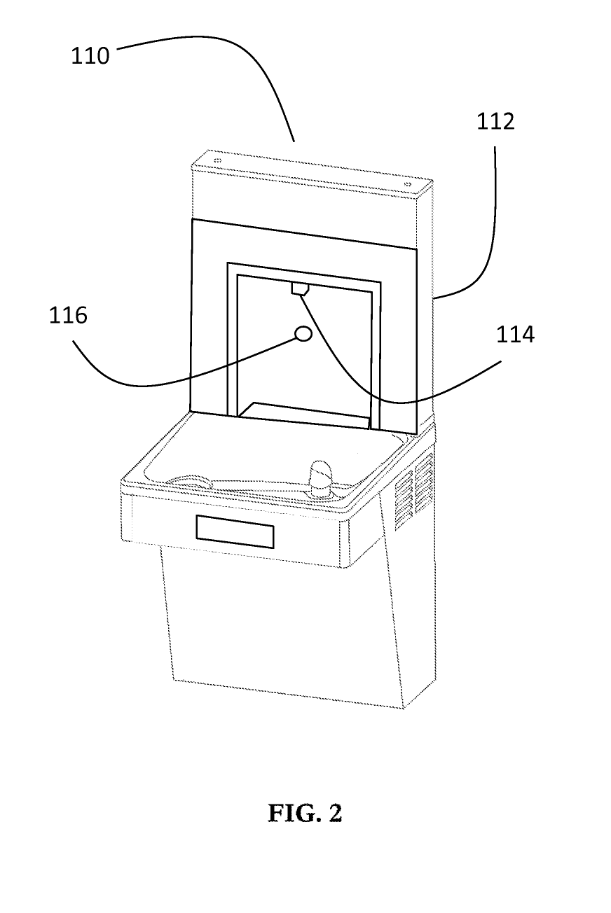

FIG. 2 illustrates an enhanced drinking fountain 110. Enhanced drinking fountains are generally comprised of components that exist in regular drinking fountains along with some or all of the following additional components, including, one or more water filters, one or more water filter housings, one or more bottle filling components 112, one or more bottle filling nozzles positioned to facilitate a stream of water for filling a bottle 114, a “hands free” interface for controlling the flow of water (which may include a motion sensor positioned to have a line of sight from a bottle filling component 116), a water usage monitoring device for estimating the proper timing of filter changes, and connections between mains water, filter housing(s), a water cooling device and the nozzles for dispensing water. Filters, water connections, the drain connection, electrical connections and the water chilling device are typically situated within the housing(s).

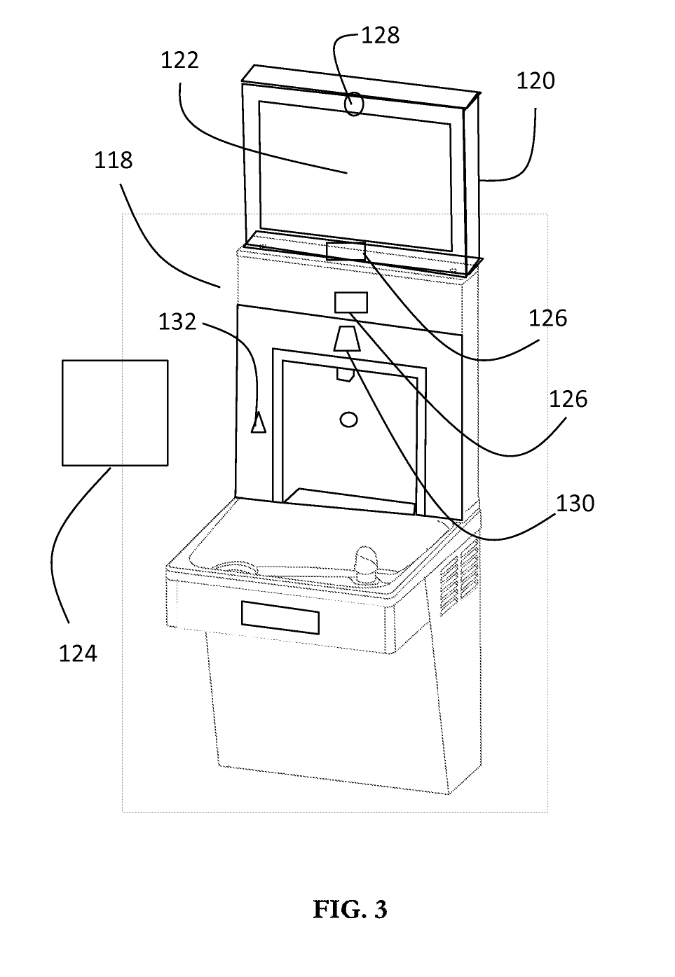

FIG. 3 illustrates an enhanced drinking fountain with an enclosure for a media display device 118. The water dispensing apparatus of the present invention may include some or all of the components of an enhanced drinking fountain, along with some or all of the following additional components, including, a housing for a media display device 120, a media display device that displays media content 122, a wide area connection between the media display device and a remote server 124, one or more interfaces to convey information from a user to a remote server, an interface that conveys information between a user and the media display device, a vending apparatus and electrical power lines that connect the media display device and related components, and the vending apparatus, to a source of electrical power.

In an embodiment the housing(s) may be constructed from metal and/or composite material. In an embodiment the housing may be mounted to a wall or the housing may be freestanding and sit or be mounted to the ground. In an embodiment the basin(s) may be constructed from a metal such as stainless steel. In an embodiment the connection to mains water is made with a brass fitting. In an embodiment the connection to a drain line is made with a PVC or brass pipe. The interface for controlling the flow of water is such to enable a user to cause a flow of water to come through a bubbler nozzle and/or a bottle filling nozzle. In an embodiment the interface includes one or more buttons that that are connected by electrical wire(s) to one or more solenoid valves. When a user presses the button, the solenoid valve releases the flow of water through a nozzle. In an embodiment the interface for controlling the flow of water may include a sensor that is positioned to detect when a user has placed a bottle under a bottle filling nozzle. The sensor may be an infrared sensor. The sensor may be connected by electrical wire to a solenoid valve. When the bottle is placed under the nozzle, it is detected by the sensor, which informs the solenoid valve to release the flow of water. In an embodiment the compressor may be connected to a receptacle for holding cold water and the receptacle may be connected to nozzles for dispensing water. Embodiments also include one or more filters and one or more filter housings. Filters may be one or more of sediment, carbon, ceramic, reverse osmosis, and or some other type of filter not listed here or a combination of filter types. The filter(s) sit in filter housing(s) that may be constructed out of metal, plastic or a composite material. The filter housing(s) have plastic and/or brass connections to mains water. If there is a water cooling device it may be connected to the filter housing and one or more nozzles via plastic and/or brass connections. For embodiments that do not include a water cooling device, the filter housing is connected to one or more nozzles via plastic and/or brass fittings.

One aspect of the present invention provides a water dispensing apparatus that includes one or more components that facilitate the dissemination of information in the form of media content, including advertorial content, and the collection of revenue from advertising, related promotional serves services and vending. In some cases property owners will appreciate the ability to display media content to the visitors of their property. In order to provide a means to disseminate information to users and to provide value to advertisers the water dispensing apparatus described herein may be configured with a media display device that can display media content to users who utilize the apparatus or who come into proximity of it. The media display device includes a screen that can display media content. The media display device may be positioned in a manner that makes it visible to users who utilize the water dispensing apparatus to dispense drinking water. The media display device may be enclosed in a housing that also encloses components of the enhanced drinking fountain, or alternatively, the media display device may be enclosed in a separate housing that can be mounted adjacent to an enhanced drinking fountain. By providing users with access to drinking water the water dispensing apparatus attracts users into proximity of the media content. Said media content may include advertorial content that promotes the products and/or services of one or more advertisers. The screen may be a LED, an LCD, a plasma, or some other type of screen that can display media content. The screen may be a touch screen monitor. The media display device may include one or more speakers for playing audible content. The media display device may include a motion sensor and be configured to initiate the playing of media content when the motion of a person is detected by the sensor. The media display device may include a media player. The media player may be a computer that includes the capacity for storing machine readable data including media content and includes the capacity to run software programs that access the data. The media player may be connected to the screen and the speakers such that it can play visual media content on the screen and audio content through the speakers. In an embodiment the media content may include digital media that has been specified by a software application such as an application written in the HTML5 markup language. Such a software application may run on the media player and utilize data that may be stored on the media player and/or a live feed of data that may be downloaded from a remote server. In an embodiment the media content may be a digital media presentation that includes one or more of the following elements: images, graphics, video and audio. In an embodiment, the digital media presentation may be a playlist of digital media that plays in a loop, or a live feed of digital media that streams over a wide area connection between a content source and the media display device, or content specified by one or more software applications, or some combination of a playlist, a live feed and content specified by one or more software applications.

The water dispensing apparatus described herein provides for the efficient and profitable operation of a network of said water dispensing apparatuses that have been deployed in a plethora of locations over a wide area. While in an embodiment the media display device includes one or more wired data ports such as a USB data port that can be used to manually transfer media content from a digital storage device onto the media display device, it may be prohibitively expensive to manually update media content using this manual method when a network operator is managing a plethora of apparatuses deployed over a wide area. The present invention solves this problem by specifying that the water dispensing apparatus include a wide area connection between the media display device and a remote server, wherein the remote server may be the source of media content. In order to effectuate the wide area connection between the media display device and a remote server over the Internet, the media display device may include one or more of the following: a wire line data port such as an Ethernet data port connected to a modem, one or more wireless antennas, a wireless interface (which can be a Wi-Fi access point that is wired to the network), a cellular Wi-Fi hotspot, which is a Wi-Fi access point that connects to the cellular network, a direct cellular connection, a Bluetooth connection, or other wireless connection. A remote server may be a computer that can store machine readable data and run software applications that utilize said data. The remote server can be configured to deliver media content and other data to, and to receive data from, one or more media players over a wide area connection. A network operator can use software to inform a remote server to specify a particular list, schedule or stream of media content to be played on each media player in a given network. The media player can be configured to receive media content and other data from a remote server, and to send data to a remote server.

The proliferation of Internet connected mobile devices such as laptops, smartphones, tablets and wearable devices has created new opportunities for advertisers and consumers to connect with each other in out of home locations. Prior art includes many examples where consumers can use a mobile device to interact with remote servers in response to digital and non-digital advertorial content in out of home locations. By providing access to drinking water the water dispensing apparatus described herein attracts users into proximity of a media display device that displays media content, including advertorial content. To provide convenience for users, to provide additional value for advertisers and to provide additional revenue opportunities for network operators, the water dispensing apparatus described herein may include one or more interfaces to convey information from a user to said media display device or to a remote server. Said information from a user to said media display device or to a remote server may be in response to information displayed on said media display device.

One interface may be a touch screen that displays media content wherein said media content includes graphical information indicating one or more interactions that a user may perform by touching the screen. In one embodiment the media player includes software that is configured to interpret and respond to user inputs on the touch screen. Another interface may involve the placement on the water dispensing apparatus or on the screen of the media display device an instruction to a user regarding a manner by which said user can convey information to said media display device or to a remote server. Said instruction may include a URL that said user may type into a web browser or may include an SMS short code to which said user may send a message indicating a response from said user.

Another interface to convey information from a user to said media display device or to a remote server may be one or more near field coupling devices. One near field coupling device may include one or more NFC tags 126 affixed on the surface of the water dispensing apparatus along with a graphic that indicates to users the location of said NFC tag. Each NFC tag may be programmed to inform NFC enabled devices such as a smartphone to perform one of many possible functions, including for example, to direct a web browser on said smartphone to point at a particular URL. When a user places their NFC enabled device into close proximity to the NFC tag, said device's web browser may be directed to perform one or more functions, including for example, to point at a particular URL. The URL may be associated with a website hosted on a remote server that includes information relating to the media content that is displayed on the media display device. The website may invite a user to perform one or more interactions, including but not limited to interactions related to media content displayed on the media display device. A remote server may be configured with software that is programmed to respond to particular user interactions performed by said user through said user's mobile device.

Another near field coupling device may include one or more one or two dimensional codes 128 that are positioned on the surface of the water dispensing apparatus or are displayed within a digital media presentation that appears on the media display device. The one or two dimensional code may be encoded to inform a mobile device such as a smartphone equipped with optical scanning capabilities to perform one or more functions, including for example, to direct said mobile device's web browser to point at a particular URL. A user may utilize the optical scanning capability of a mobile device to scan a one or two dimensional code, which may inform said mobile device's web browser to point at a particular URL. The URL may be associated with a website hosted on a remote server that includes information relating to the media content that is displayed on the media display device. The website may invite a user to perform one or more interactions, including interactions related to media content displayed on the media display device. A remote server may be configured with software that is programmed to respond to particular user interactions performed by said user through said user's mobile device.

Another near field coupling device may include a NFC tag reader 130 that is positioned at or near the surface of the water dispensing apparatus, along with a graphic that indicates to users the precise location of said reader. The NFC reader is configured to read one or more different types of NFC tags. The NFC reader may be connected to the media player via a wired or wireless data connection. There may be a translating circuit board connected between the NFC tag reader and the media player. The media player may be configured to run software that is able to perform functions involving data received from the NFC reader. A user may have an NFC tag that is encoded with information associated with said user. A user's NFC tag may be on said user's mobile device, or it may be affixed or embedded into a smart card, or it may be affixed, attached to, or embedded into a refillable water bottle or it may be affixed to, attached to, or embedded into some other object. When a user places an NFC tag into close proximity with the NFC tag reader the NFC tag reader informs software on the media player that said NFC tag has been scanned. Software on said media player may be configured to perform one or more functions upon receipt of said information, including for example, transmitting said information to a remote server.

Another near field coupling device may include an optical scanner 132 that is positioned at the surface of the water dispensing apparatus, along with a graphic that indicates to users the precise location of said scanner. The optical scanner is configured to read one or more different types of one or two dimensional codes. The optical scanner may be connected to the media player via a wired or wireless data connection. There may be a translating circuit board connected between the optical scanner and the media player. The media player may be configured to run software that is able to perform functions involving data received from the optical scanner. A user may have a one or two dimensional code that is encoded with information associated with said user. In one embodiment the code may be a bar code. In another embodiment the code may be a quick response code. A user's one or two dimensional code may be stored in digital format on said user's mobile device, or it may be affixed to or printed on a smart card, or it may be affixed to, attached to or printed on a refillable water bottle or it may be affixed to, attached to, or printed on some other object. When a user places a one or two dimensional code into viewing range of the optical scanner, the optical scanner informs software on the media player that said one or two dimensional code has been scanned. Software on said media player may be configured to perform one or more functions upon receipt of said information, including for example, transmitting said information to a remote server.

Additional interfaces may exist to convey information between the media display device and one or more people who come into proximity of the apparatus. These interfaces may include a radio communications device, possibly including a MIMO (multiple input multiple output) radio or diversity communications radio, a Bluetooth connection, a Bluetooth low energy beacon and a motion sensor.

The interfaces described above to convey information from a user to the media display device and to a remote server generally facilitate interactions that will benefit a property owner and/or a network operator and/or one or more advertisers who pay to have advertorial content displayed on said media display device. One such interaction may inform software on said media display device or software on a remote server of the intent of a user to purchase a product or a service. Said product or service may be offered by an advertiser that has paid to have advertorial content played on said media display device. Another such interaction may inform software on said media display device or software on a remote server of the intent of a user to participate in a contest. Said contest may be sponsored by one or more advertisers who pay to have advertorial content displayed on said media display device. Another such interaction may inform software on said media display device or software on a remote server of the intent of a user to receive a coupon for a product or a service. Said product or service may be offered by an advertiser who pays to have advertorial content displayed on the media display device. Another such interaction may inform software on said media display device or software on a remote server of the intent of a user to download digital content to said user's mobile phone. Said digital content may be information about a product or a service offered by an advertiser who pays to have advertorial content displayed on said media display device, or it may be an application that invites engagement with a property owner, the network operator or an advertiser who has paid to have advertorial content displayed on said media display device, or it may be some other type of digital content. Another such interaction may inform software on said media display device or software on a remote server of the intent a user to post a message to a social media account. Software on said media display device or on said remote server may utilize an API of an operator of said social media service to effectuate said post. Said post may be on said user's social media account or may be on an account of a property owner, a network operator or an advertiser who pays to have advertorial content displayed on said media display device. Said post may report that said user has utilized said water dispensing apparatus to obtain a drink of water. Said post may include a digital image from said user. Said post may refer to an advertiser who pays to have advertorial content on said media display device.

Another interaction may inform software on said media display device or software on a remote server of the location of a user. Software on said media display device or software on a remote server may be configured to send location specific information to said user's mobile device. Said location specific information may include information related to products or services in proximity to said location, including for example information about products or services offered by an advertiser who pays to have advertorial content displayed on said media display device. Another interaction may inform software on said media display device or software on a remote server of one or more identifying characteristics of said user. Said characteristics may include said user's name, or an account ID associated with said user (such as a social media account) or an unique ID associated with said user's refillable water bottle or with said user's mobile phone, or certain characteristics of said user such as said user's email address, phone number, age or gender, or some other feature or characteristic associated with said user. Software on said media display device or on a remote server may be configured to perform one or more functions that utilize one or more identifying characteristics of said user. Another interaction may inform software on said media display device or on a remote server of the identity of a user who has obtained water from said water dispensing apparatus or the identity of a bottle that said user has filled with water from said water dispensing apparatus. Said bottle may have a unique ID that is associated a user. Software on said media display device or on a remote server may be configured to record the day and time when a user has obtained water from said water dispensing apparatus or to record the day and time when a particular bottle has been filled with water from said water dispensing apparatus.

The water dispensing apparatus described herein may include a water usage monitoring device that can measure the amount of water that passes through the apparatus and one or more interfaces for sending water usage information to a remote server. The water usage monitoring device may include a flow meter that measures the amount of water that is dispensed by the apparatus. The flow meter may include or be connected to a circuit board that is configured to translate water usage information into machine readable data. The circuit board connected to the flow meter may have a wired or wireless data connection to the media player. Or the circuit board may have a wired or wireless connection to a remote server. The circuit board or the media player or the remote server may be configured to associate said data with a particular time when said data was collected. The media player may have software that is configured to perform one or more functions related to data derived from the flow meter. One such function may include the sending of said data to a remote server.

Alternatively the water usage monitoring device may include a circuit board that is connected via wire to one or more solenoid valves or to one or more switches that control said solenoid valves. Said circuit board may be configured to record the duration of time said solenoid valves are open. Said circuit board may be connected to a media player via a wired or wireless connection. Or said circuit board may have a wired or wireless connection to a remote server. Said circuit board or media player or remote server may be configured to translate the data from the solenoid valves into an estimate of the amount of water that has passed through the water dispensing apparatus. The circuit board or the media player or the remote server may be configured to associate said data or said estimate with a particular time when said data or said estimate was collected. The media player may have software that is configured to perform one or more functions related to data derived from the solenoid valves. One such function may include the sending of said data to a remote server.

The water dispensing apparatus may include one or more mechanisms for recording when a filter has been changed. One mechanism may involve a manual interface between a person and a circuit board by which said person can inform said circuit board when a filter has been changed. Said circuit board may be connected to the media player or to a remote server. Another mechanism may involve the deployment of filters each have a unique tag such as a NFC tag and the deployment of a NFC reader that can detect when a new filter has been installed into the apparatus. The NFC reader may be connected to the media player or to a remote server. There may be a translating circuit board connected between the NFC reader and the media player or a remote server. The media player or a remote server may include software that is configured to record each instance, including the date and time, when a filter is changed. The media player may include software that is configured to send said data about each instance to a remote server. The media player or the remote server may include software that is configured to perform one or more functions related to recorded instances of filter changes. One such function may be to indicate to a person when it is time to change a filter. Said indication may be transmitted as an email or an SMS message or as some other type of electronic message.

A remote server may include software that is configured to perform one or more functions relating to water usage data collected from a water usage monitoring device. One such function may include informing one or more software applications about the amount of water that has passed through a particular water dispensing apparatus, or about the amount of water that has passed through a particular network of water dispensing apparatuses. A network operator may deploy one or more software applications that can utilize or publicize the water usage information collected from one or more water usage monitoring devices.

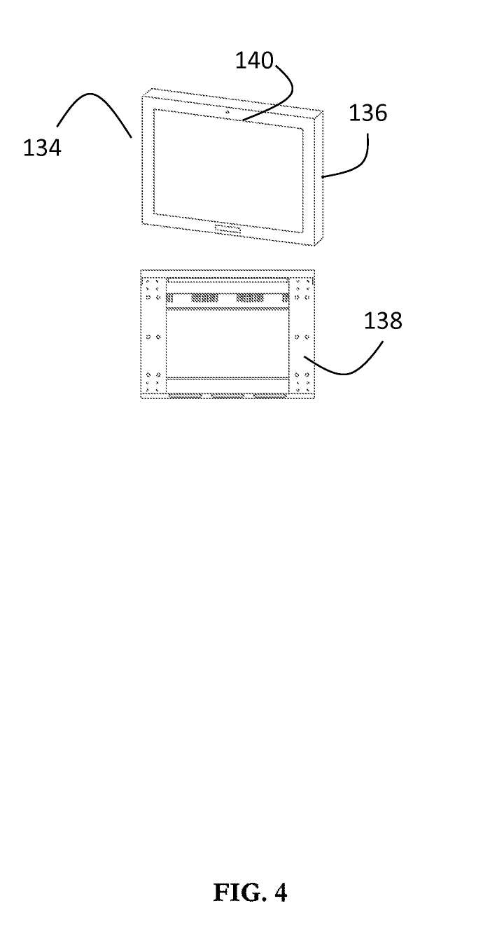

FIG. 4 illustrates a media display kit that may be retrofitted onto an enhanced drinking fountain 134. The invention described herein includes a media display kit that can be added onto an enhanced drinking fountain. This kit includes a media display device and may also include an enclosure 136 and mounting bracket 138 for mounting the media display device above an enhanced drinking fountain and one or more components to establish a wide area connection between said media display device and a remote server. 138 shows a rear view an enclosure revealing the mounting bracket which can be used to mount the enclosure to wall. The enclosure may include an opening 140 through which a user can see media content displayed on the media display device. The media display kit may include one or more components necessary to establish one or more interfaces for conveying information from a user to said media display device or to a remote server. Said interfaces may include one or more near field coupling device(s) and/or a mobile device of said user.

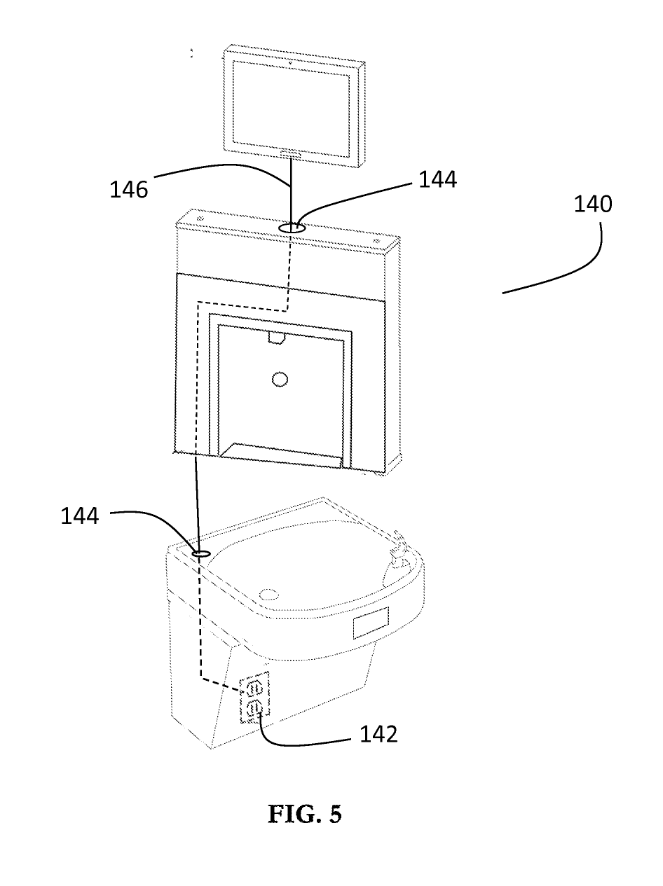

FIG. 5 illustrates a manner of modifying an enhanced drinking fountain so as to facilitate an electrical connection between a media display device and an electrical receptacle 140. The invention also includes a method for retrofitting a media display kit onto an enhanced drinking fountain. This method may include modifying an enhanced drinking fountain in a manner that facilitates connecting one or more components of said media display device to an electrical receptacle 142 that may be located behind a housing of said enhanced drinking fountain. Said method may involve drilling one or more holes 144 through one or more housings of said enhanced drinking fountain in order to create a passage through which one or more electric cords 146 can be extended from one or more components of said media display device to said electrical receptacle. The enclosure of said media display device may include one or more openings through which one or more electrical cords may be extended from one or more components of said media display device into one or more holes in said housing of said enhanced drinking fountain. The method described in this paragraph enables a media display device installed adjacent to an enhanced drinking fountain to be connected to a source of electrical power without the need to install an additional electrical receptacle and without the unsightly appearance of extending a power cord from a media display device along a wall to an electrical receptacle. An enhanced drinking fountain that has been retrofitted with a media display kit may be referred to as a water dispensing apparatus.

The invention described herein may include a method whereby a network operator adds one or more components to a drinking fountain or an enhanced drinking fountain. This method may involve replacing a filter system of a drinking fountain with a different filter system or adding a filter system to a drinking fountain or enhanced drinking fountain.

The invention described herein includes a method for operating one or more water dispensing apparatuses. This method may include the establishment of a contractual relationship with one or more property owners granting a network operator rights to operate a water dispensing apparatus on property controlled by said property owner(s). This method includes the establishment of a contractual relationship with at least one advertiser who agrees to pay for media content to be displayed on one or more water dispensing apparatuses. This method includes the deployment of one or more water dispensing apparatuses in one or more locations controlled by said property owner(s). This method may include transmission of media content, including advertorial content promoting said advertiser, from a remote server to one or more water dispensing apparatuses. This method includes the playing of said media content on the media display device of said water dispensing apparatus. This method includes the collection of revenue from said advertiser in exchange for the playing of said advertorial content on said water dispensing apparatus. The amount of revenue collected from said advertiser may be based on a percentage of screen time devoted to said advertorial content of said advertiser, or it may be based on the number of times a segment of promotional content of said advertiser is played on said media display device, or it may be based on the number of times a user indicates a response to advertorial content of said advertiser, or it may be based on a percentage of sales generated in response to said advertorial content of said advertiser, or it may be based on an estimate of an amount of water that has passed through said water dispensing apparatus. The amount of revenue collected from said advertiser may be shared with said property owner(s). The media player and/or a remote server may include software that is configured to record information about the duration of time advertorial content of said advertiser has played on said media display device, and/or the number of times a particular segment of advertorial content of said advertiser has played on said media display device, and/or instances of user response(s) to advertorial content of said advertiser.

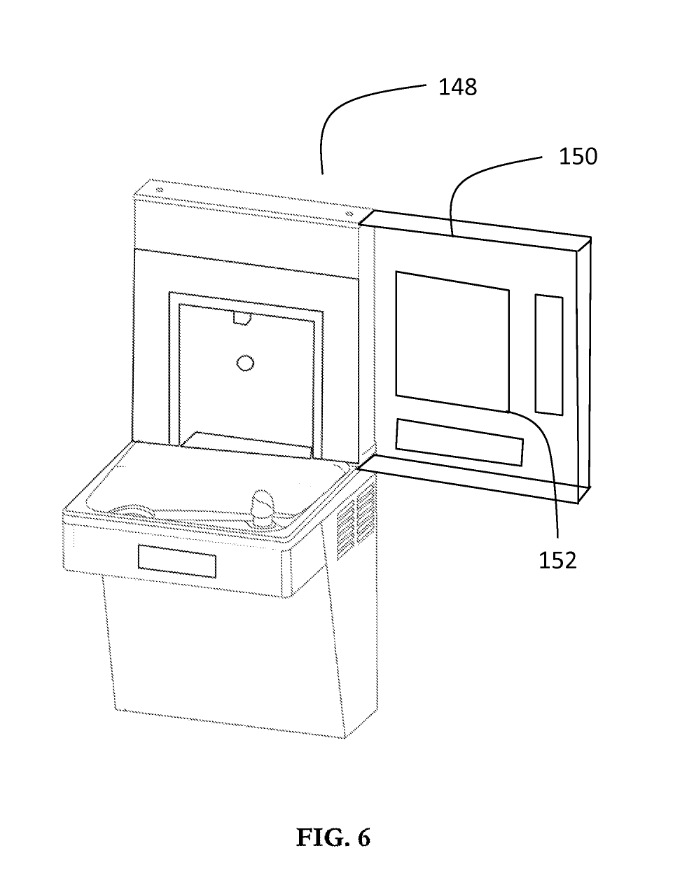

FIG. 6 illustrates an enhanced drinking fountain with a vending apparatus 148. The invention described herein may include an enhanced drinking fountain combined with a vending apparatus. The vending apparatus 150 is configured to dispense products in exchange for payments. The vending apparatus includes an interface by which a user can indicate a product and make a payment for said product. The vending apparatus may include a media display device 152 and one or more interfaces for conveying information from a user to a media display device or to a remote server. The vending apparatus may be enclosed within a housing that also encloses one or more components of the enhanced drinking fountain. The vending apparatus may be enclosed in a separate housing that is mounted in proximity to or adjacent to the enhanced drinking fountain. The vending apparatus may be configured to dispense products that are related to drinking water. Said products may include a water bottle and/or a disposable cup and/or a package of one or more substances that a user can add to drinking water. Said substances may enhance the flavor or nutritional content of said drinking water.

The invention described herein may include a vending kit that can be added onto an enhanced drinking fountain. The vending kit includes a vending apparatus that is enclosed in a housing that may be mounted in proximity to or adjacent to the enhanced drinking fountain. The vending apparatus included in the vending kit includes an interface by which a user can indicate a product and make a payment for said product. The vending apparatus included in the vending kit may include a media display device and one or more interfaces for conveying information from a user to a media display device or to a remote server. The vending apparatus included in the vending kit may be configured to dispense products that are related to drinking water. Said products may include a water bottle and/or a disposable cup and/or a package of one or more substances that a user can add to drinking water. Said substances may enhance the flavor or nutritional content of said drinking water.

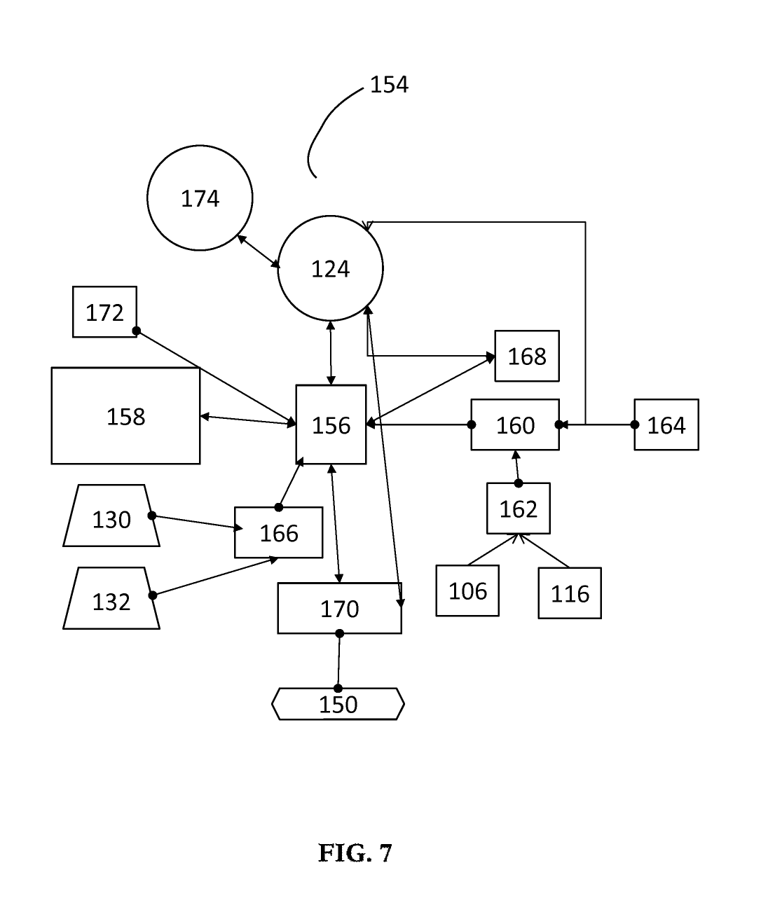

FIG. 7 illustrates a diagram of various connections that may exist between components of an example of the invention 154. A remote server 124 may be connected to the media player 156 of a media display device 122. Said connection may be a wireless or wired wide area connection. Said remote server may be the source of media content that is displayed on one or more media display devices. Said remote server may receive one or more types of data from a media player. A media display device 122 includes a screen 158 for displaying media content. Said screen may be connected to a media player 156. One or more circuit boards 160 may be connected to one or more other components. A circuit board 160 may be connected to one or more solenoid valves or solenoid valve switches 162. One or more solenoid valves may be connected to an interface (such as a button 106 or a “hands free” sensor 116) by which a user can control the flow of water. A circuit board 160 may be connected to a flow meter 162. Said circuit board 160 may be connected to a media player 156 or to a remote server 124 and through said connection send water usage information to said media player or to said remote server. Another circuit board 164 may be connected a NFC tag scanner 130 or an optical scanner 132. A connection may exist between a user's computer (such as a smartphone, tablet or laptop) 168 and a media player 156 or between a user's computer 168 and a remote server 124. A vending apparatus 150 may include a circuit board 170 that is connected to a media player 156 or is connected to a remote server 124. A motion sensor 172 may be connected to a media player 156. A remote server 124 may be connected to one or more other remote servers 174.

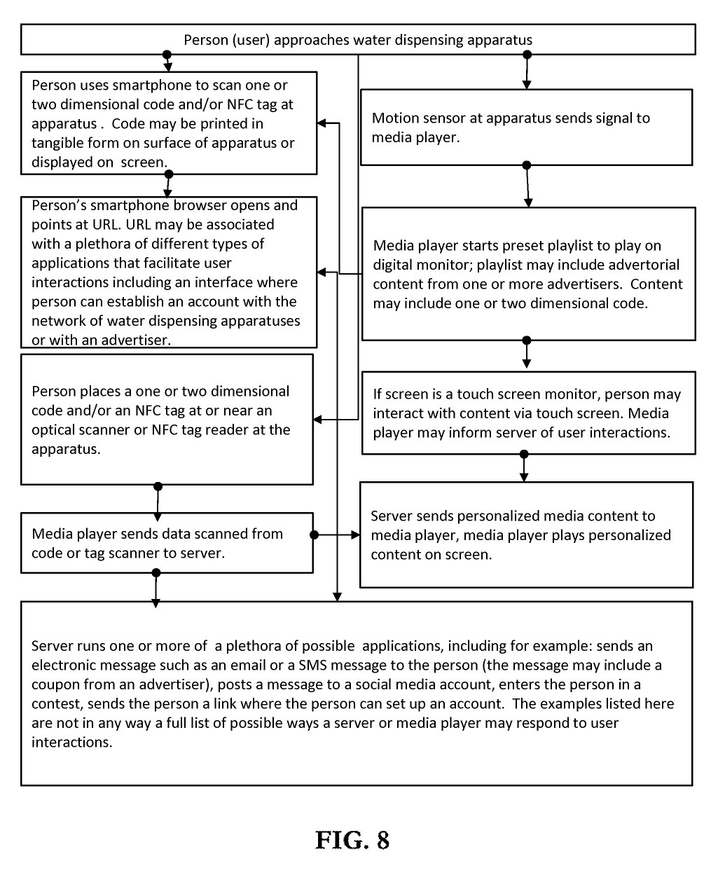

FIG. 8 illustrates a diagram of various interactions between a user and a water dispensing apparatus.

The invention described herein may include the deployment of one or more software applications that provide a graphical interface through which a user may create an account. The software may reside on a web server or it may be downloaded onto a user's device, such as a computer, tablet or smartphone. A user's account may be associated with one or more unique IDs. A user may associate an account with said user's identity on one or more social networks such as Twitter or Facebook. A user may associate an account with one or more pieces of information such as a name, age, gender, address, email address, phone number or other type of information. The software application of this paragraph may be configured to utilize the API of one or more social networks. The water dispensing apparatus may inform a remote server of information related to interactions with said apparatus. A media display device or remote server may be configured with software that associates user interactions at said water dispensing apparatus with said user's account. A media display device or a remote server may include software that is configured to respond to interactions associated with a user's account. Such a response may include a real time customization of media content on said media display device wherein said customization is based on one or more characteristics associated with said user's account.

For the purposes of this disclosure, property owners shall include property owners, property managers or leaseholders of a given property, and network operators shall include parties who operate one or more units of the water dispensing apparatus described herein on one or more properties. A property owner may also be a network operator. A property owner or a network operator may also be an advertiser.

A water dispensing apparatus may be configured to dispense both flat and carbonated water.

1. A water dispensing apparatus comprising:
a first interface for controlling flow of water,
a media display device that displays media content, and
a wide area connection between said media display device and a remote server, wherein said remote server is the source of said media content.

2. The apparatus of claim 1, wherein said media content is a playlist or is a live feed or is a combination of a playlist and a live feed.

3. The apparatus of claim 1, further comprising a second interface to convey information from a user to said media display device or from a user to a remote server.

4. The apparatus of claim 3, wherein said information is in response to media content displayed on said media display device.

5. The apparatus of claim 3 wherein said second interface to convey information from a user is a near field coupling device.

6. The apparatus of claim 3 wherein said second interface to convey information from a user is a user's mobile device.

7. The apparatus of claim 3, wherein said information conveyed from said user to said media display device or to said server informs software of the intent of said user to purchase a product or a service, to participate in a contest, to receive a coupon for a product or a service, to download digital content to said user's mobile phone, or to post a message to a social media account.

8. The apparatus of claim 3, wherein said information conveyed from said user to said media display device or to said server informs software of the location of said user or of the identity of said user.

9. The apparatus of claim 3, wherein said information conveyed from said user to said media display device or to said remote server is a digital image.

10. The apparatus of claim 3, wherein said information conveyed from said user to said media display device or to said remote server informs software that said user has dispensed water from said water dispensing apparatus or that a bottle associated with said user has been detected at said water dispensing apparatus.

11. The apparatus of claim 1, further comprising a water usage monitoring device, wherein said wide area connection can be used to convey water usage information to a remote server.

12. The apparatus of claim 1, further comprising a water usage monitoring device, wherein a third interface conveys water usage information from said water usage monitoring device to a remote server.

13. A method of using a water dispensing apparatus, comprising:
establishing a contractual relationship with at least one property owner and at least one advertiser,
deploying a water dispensing apparatus in at least one location controlled by said property owner, wherein the water dispensing apparatus includes:
a first interface for controlling flow of water,
a media display device that displays media content, and
a wide area connection between said media display device and a remote server, wherein said remote server is the source of said media content,
playing media content on a media display device wherein said media content includes advertorial content of said advertiser, and
collecting revenue from said advertiser.

14. The method of claim 13 wherein the amount of revenue collected from said advertiser is based on a percentage of screen time devoted to said advertorial content of said advertiser, or is based on the number of times a segment of promotional content of said advertiser is played on said media display device, or is based on the number of times a user indicates a response to advertorial content of said advertiser, or is based on a percentage of sales generated in response to said advertorial content of said advertiser, or is based on an estimate of an amount of water that has passed through said water dispensing apparatus.

15. A method of preparing the water dispensing apparatus of claim 1, comprising:
modifying a drinking fountain whereby access is gained to an electrical receptacle,
mounting a media display device at said drinking fountain,
connecting said media display device to said electrical receptacle, and
connecting said media display device to a remote server, wherein said remote server is the source of content for said media display device.
